(19) United States
(12) Patent Application Publication
(10) Pub. No.: US 2025/0360736 A1
(43) Pub. Date: Nov. 27, 2025

(54) PRINTING APPARATUS

(71) Applicant: SCREEN Holdings Co., Ltd., Kyoto (JP)

(72) Inventors: Yuki TSUTSUI, Kyoto-shi (JP); Junichi SHIMIZU, Kyoto-shi (JP); Daiki MATSUKAWA, Kyoto-shi (JP); Mitsuru TANEMOTO, Kyoto-shi (JP); Takahiro UDA, Kyoto-shi (JP)

(21) Appl. No.: 19/207,525

(22) Filed: May 14, 2025

(30) Foreign Application Priority Data
May 23, 2024 (JP) 2024-084329

(51) Int. Cl. B41J 15/16; B41J 11/00; B41J 15/04; B41J 29/377; B41M 7/00

(52) U.S. Cl. CPC B41J 15/165; B41J 11/0021; B41J 11/0022; B41J 15/046; B41J 29/377; B41M 7/009

(57) ABSTRACT

In a printing apparatus, web paper is transported by guide rollers and path changing rollers to a printing face contact roller in a swirling form. In a first section, the web paper is heated and dried by heating units facing thereto. The path changing rollers change and bypass a path of the web paper in a second section, downstream of the first section, and thus the path of the web paper in the second section is made longer. In the first section, since the web paper is heated and dried by the heating units, the web paper in the second section has the highest temperature. Therefore, by making the web paper longer in the second section, the web paper can be dried more efficiently in the second section. This results in enhanced drying efficiency of the web paper without increasing energy required for drying.

### CROSS-REFERENCE TO RELATED APPLICATIONS

This application claims priority to Japanese Patent Application No. 2024-084329 filed May 23, 2024, the subject matter of which is incorporated herein by reference in entirety.

### TECHNICAL FIELD

The present invention relates to a printing apparatus for performing printing on an elongated print medium.

### BACKGROUND ART

A printing apparatus includes a drying mechanism configured to dry inks adhering to a print medium (e.g., web paper). The drying mechanism uses, as an example, a heating drum, an air blowing means, or an infrared heating means to heat a print medium to which inks for printing are adhered, thereby drying the inks.

As a currently used drying mechanism for drying inks, the following configuration has been suggested (see, for example, Patent Literature 1). Specifically, a print medium with inks on its surface is guided into the drying mechanism via an inlet of the drying mechanism. Then, a plurality of turning rollers contacts a back face (non-printing face) of the print medium, and each of the turning rollers changes a direction of the print medium, thereby transporting the print medium in a swirling form. A heating unit is arranged between adjacent turning rollers so as to face a printing face of the print medium. Each of the heating units heats the printing face of the print medium to dry the inks with the air blowing means or the infrared heating means. In other words, the print medium is sequentially heated with the heating units while its direction is turned in a swirling form by the turning rollers.

The print medium transported in a swirling form while being heated by the heating units is guided to a printing face contact roller. The printing face contact roller firstly contacts the printing face of the print medium after the inks adhere to the print medium. Accordingly, a process of drying the printing face to which the inks adhere is completed until the print medium is transferred to the printing face contact roller. Then, the printing face contact roller contacts the printing face of the print medium, whereby the print medium is folded and is guided along a direction toward an outlet of the drying mechanism. Such a configuration of heating while arranging a transportation path of the print medium in a swirling form allows reduction in size of the drying mechanism.

### PRIOR ART DOCUMENT

### Patent Literature

### Patent Literature 1

Japanese Unexamined Patent Publication No. 2022-037537

### SUMMARY OF INVENTION

### Technical Problem

However, the conventional example with such a configuration as above possesses the following drawbacks. In other words, in recent years, productivity and a printing quality of the printing apparatus have been enhanced, requiring further enhanced drying efficiency for the print medium. As for a method for enhancing the drying efficiency, such a method is typically used as one for increasing a heating temperature by heating units or increasing the number of heating units to be installed. However, such a method requires more energy for drying, and a problem is concerned that the drying mechanism becomes larger due to an increase in number of heating units. In other words, with the currently-used apparatus, it is difficult to sufficiently enhance the drying efficiency while avoiding an increase in energy required for drying.

The present invention has been made regarding the state of the art noted above, and its one object is to provide a printing apparatus that can enhance drying efficiency for a print medium while avoiding an increase in energy required for drying.

### Solution to Problem

Inventors herein have made a study on the problem to obtain the following finding. Specifically, in the printing apparatus with the conventional construction, a temperature of the print medium gradually increases as it is sequentially heated by the heating units while the print medium is transported in a swirling form. That is, in the print medium guided inside of the drying mechanism, a temperature of the print medium is the highest at a region between a turning roller located directly downward of a heating unit heating the print medium finally (hereinafter, referred to as “final turning roller”) and the printing face contact roller. In other words, drying efficiency of inks on the print medium is the highest in the region between the final turning roller and the printing face contact roller. However, since a path of the print medium between the final turning roller and the printing face contact roller is short, it is considered that the currently used drying mechanism does not sufficiently enhance the drying efficiency of the print medium.

The present invention is constituted as stated below to achieve the above object.

One aspect of the present invention provides a printing apparatus, including a printing unit configured to cause inks to adhere to a printing face of an elongated print medium to be transported, and a drying mechanism configured to dry the inks by heating the print medium unloaded from the printing unit, the drying mechanism including a plurality of turning rollers configured to turn a transportation direction of the print medium a plurality of times by contacting a rear face of the print medium unloaded from the printing unit with no inks adhering thereto, and configured to transport the print medium in a swirling form, a plurality of drying units arranged so as to face the printing face of the print medium transported in a swirling form, and configured to dry the inks by heating the print medium, a printing face contact roller located downstream of a first section in a spiral transportation section of the print medium, the first section being a section where the drying units are arranged, and configured to contact the printing face of the print medium firstly to fold the print medium, and a path changing roller located at a second section where the print medium is transported to the printing face contact roller from a turning roller of the turning rollers that is located downstream of the first section and closest to the first section, and configured to contact the rear face of the print medium in the second section to change and bypass a transportation path of the print medium.

With the printing apparatus according to the present invention, the turning rollers to contact against the rear face, whereby the elongated print medium is transported in a swirling form while being redirected. In the first section of the transportation section in the swirling form, the drying units are arranged so as to face the printing face of the print medium, and heat the print medium to dry the inks. The printing face contact roller is located downstream of the first section, and the printing face contact roller firstly contacts against the printing face of the print medium transported in a swirling form in the first section, thereby turning the transportation direction of the print medium.

Moreover, the path changing roller is located at the second section where the print medium is transported to the printing face contact roller from the turning roller of the turning rollers that is located downstream of the first section and closest to the first section. The path changing roller contacts the rear face of the print medium in the second section to change and bypass the transportation path of the print medium. In other words, compared to a straight path to the printing face contact roller from the turning roller located closest to the first section, the transportation path of the print medium in the second section can be made longer by a change in the transportation path of the print medium by the path changing roller. The second section is a section where the print medium has the highest temperature due to heating by all of the drying units. Therefore, by making the print medium longer in the second section, the print medium can be dried more efficiently in the second section. This results in enhanced drying efficiency of the print medium without any design change that increases energy required for drying, such as for installation of an additional drying unit or an increase in heating temperature of the drying units.

Moreover, it is preferred in the present invention described above that the path changing roller changes the transportation path of the print medium in the second section such that the print medium faces any of the drying units.

With the printing apparatus according to the present invention, the transportation path of the print medium in the second section is changed by the path changing roller so that the print medium is on the path facing any of the drying units. With the print medium in the second section facing any of the drying units, the drying unit that heats the print medium in the first section also heats the print medium in the second section. This results in enhanced drying efficiency of the print medium in the second section without arrangement of an additional drying unit.

Moreover, it is preferred in the present invention described above that the path changing roller changes the transportation path of the print medium in the second section such that the printing face of the print medium faces any of the drying units.

With the printing apparatus according to the present invention, the transportation path of the print medium in the second section is changed by the path changing roller so that the printing face of the print medium is on the path facing any of the drying units. With the print medium in the second section facing any of the drying units, the drying unit that heats the printing face of the print medium in the first section also heats the print medium in the second section. The drying unit heats the printing face of the print medium, achieving further enhanced drying efficiency of inks adhering to the printing face. This results in enhanced drying efficiency of the print medium in the second section without arrangement of an additional drying unit.

Moreover, it is preferred in the present invention described above that the transportation path of the print medium in the second section is arranged so as to be surrounded by the transportation path of the print medium in the first section.

With the printing apparatus according to the present invention, the transportation path of the print medium in the second section is arranged so as to be surrounded by the transportation path of the print medium in the first section. With such arrangement, the heat transferred from the drying unit to the print medium in the first section is efficiently transferred to the second section enclosed with the first section. This results in further enhanced drying efficiency of the print medium without an increase in energy required for drying. In addition, the transportation path of the print medium is made compact, achieving reduction in size of the printing apparatus.

Moreover, it is preferred that the printing apparatus according to the present invention further includes a ventilation unit that is located along a width direction of the print medium transported in the second section and is configured to ventilate gas.

With the printing apparatus according to the present invention, the ventilation unit configured to ventilates gas is provided. The ventilation unit is located along the width direction of the print medium transported in the second section. Even when vapor evaporated from the print medium in the second section stagnates in the second section, the ventilation unit can efficiently remove the vapor that stagnates around the print medium in the second section by ventilation. This results in enhanced drying efficiency of the print medium in the second section.

Moreover, it is preferred in the present invention described above that the ventilation unit is configured to supply gas, heated by the drying unit, to the second section.

With the printing apparatus according to the present invention, the ventilation unit supplies gas, heated by the drying unit, to the second section. In this case, since the gas supplied from the drying unit is low in humidity and high in temperature, humidity in the second section can be reduced efficiently. Accordingly, the drying efficiency of the print medium in the second section can be further enhanced.

Moreover, it is preferred in the present invention described above that the ventilation unit is configured to exhaust gas within the second section.

With the printing apparatus according to the present invention, the ventilation unit is configured to exhaust gas within the second section. In this case, vapor that stagnates in the second section is suitably exhausted by the ventilation unit. Accordingly, the drying efficiency of the print medium in the second section can be further enhanced.

Moreover, it is preferred that the printing apparatus according to the present invention further includes a gas circulation unit configured to circulate gas, exhausted by the ventilation unit, inside the drying mechanism.

With the printing apparatus according to the present invention, the gas exhausted by the ventilation unit is circulated inside the drying mechanism by the gas circulation unit. Such a construction can reduce an exhaust volume in the drying mechanism.

Moreover, it is preferred in the present invention described above that the ventilation unit is located between the printing face of the print medium in the second section and the printing face of the print medium downstream of the second section.

With the printing apparatus according to the present invention, the ventilation unit is located between the printing face of the print medium in the second section and the printing face of the print medium downstream of the second section. Such a construction enables the ventilation from both sides of the ventilation unit to remove vapors stagnating in the vicinity of the print medium by drying the printing face of the print medium. In other words, removal efficiency of vapor can be further enhanced, enabling more suitable drying of the print medium.

### Advantageous Effects of Invention

With the printing apparatus according to the present invention, the turning rollers contacts against the rear face, whereby the elongated print medium is transported in a swirling form while being redirected. In the first section of the transportation section in the swirling form, the drying units are arranged so as to face the printing face of the print medium, and heat the print medium to dry the inks. The printing face contact roller is located downstream of the first section, and the printing face contact roller firstly contacts against the printing face of the print medium transported in a swirling form in the first section, thereby turning the transportation direction of the print medium.

Moreover, the path changing roller is located at the second section where the print medium is transported to the printing face contact roller from the turning roller of the turning rollers that is located downstream of the first section and closest to the first section. The path changing roller contacts the rear face of the print medium in the second section to change and bypass the transportation path of the print medium. In other words, compared to a straight path to the printing face contact roller from the turning roller located closest to the first section, the transportation path of the print medium in the second section can be made longer by a change in the transportation path of the print medium by the path changing roller. The second section is a section where the print medium has the highest temperature due to heating by all of the drying units. Therefore, by making the print medium longer in the second section, the print medium can be dried more efficiently in the second section. This results in enhanced drying efficiency of the print medium without any design change that increases energy required for drying, such as for installation of an additional drying unit or an increase in heating temperature of the drying units. Accordingly, the drying efficiency for the print medium can be enhanced while an increase in energy required for drying is avoided.

### BRIEF DESCRIPTION OF DRAWINGS

FIG. 1 schematically illustrates a construction of a printing apparatus according to a first embodiment of the present invention.

FIG. 2 illustrates a construction of a drying mechanism according to the first embodiment.

FIG. 3 illustrates an overview of a path for web paper in the drying mechanism according to the first embodiment.

FIG. 4 illustrates a heating unit according to the first embodiment: FIG. 4a is a longitudinal sectional view of the heating unit along a width direction of the web paper; and FIG. 4b is a longitudinal sectional view of the heating unit along a transportation direction of the web paper.

FIG. 5 is a cross-sectional view on an A-A arrow in FIG. 3.

FIG. 6 illustrates one example of an air exhaust path according to the first embodiment.

FIG. 7 illustrates an effect of the drying mechanism according to the first embodiment.

FIG. 8 illustrates an overview of a path for web paper in a drying mechanism according to a second embodiment.

FIG. 9 illustrates one example of an air supply path according to a third embodiment.

FIG. 10 is a cross-sectional view on a B-B arrow in FIG. 9.

FIG. 11 illustrates a construction of a drying mechanism according to one modification.

FIG. 12 is a transverse sectional view of a construction of a drying mechanism according to another modification.

FIG. 13 illustrates a construction of a drying mechanism according to still another modification.

### DESCRIPTION OF EMBODIMENTS

### First Embodiment

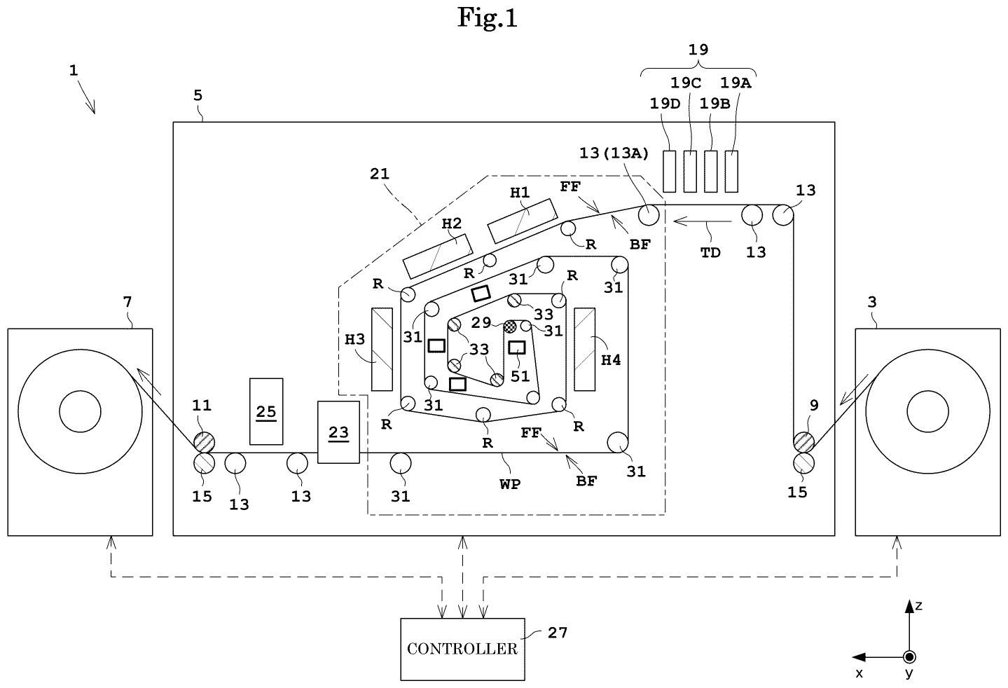

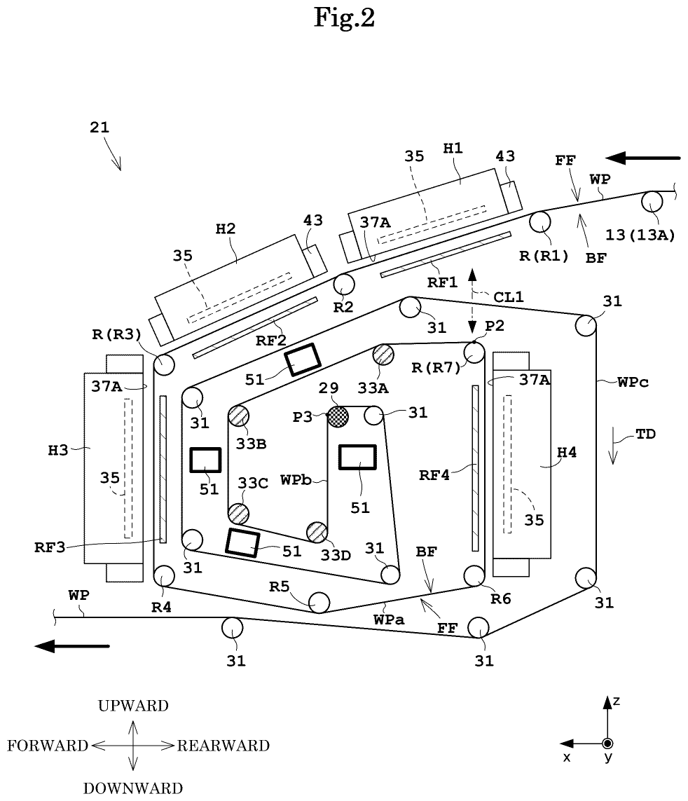

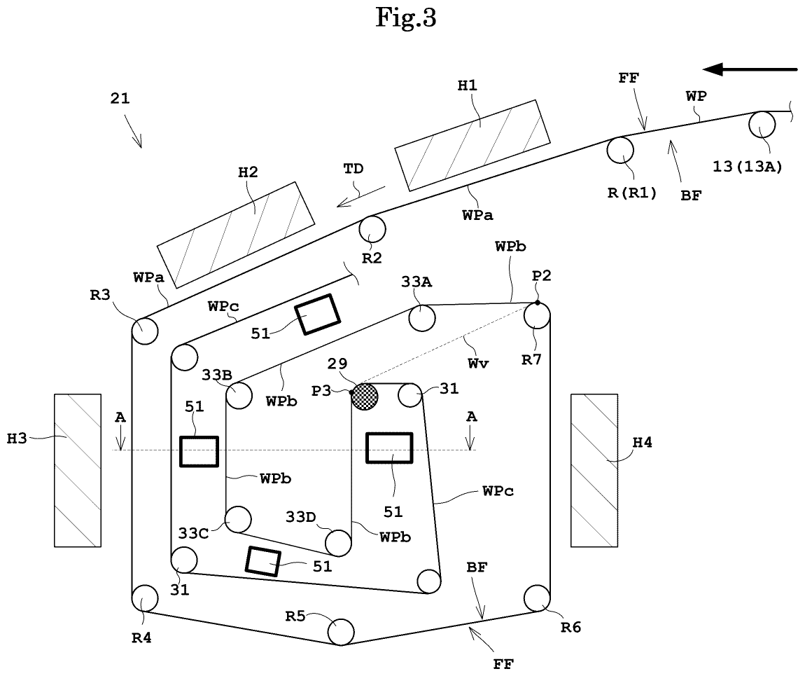

The following describes a first embodiment of the present invention with reference to drawings. FIG. 1 schematically illustrates an entirety of a printing apparatus 1 according to the first embodiment. FIG. 2 illustrates a drying mechanism 21 according to the first embodiment. FIG. 3 illustrates a principal part of the drying mechanism 21 according to the first embodiment.

### Description of Overall Construction

Reference is made to FIG. 1. The printing apparatus 1 according to the present embodiment is an inkjet printing apparatus. The printing apparatus 1 includes a paper feeder 3, a printing apparatus body 5, and a take-up roller 7.

The paper feeder 3 holds a roll of web paper (continuous paper) WP rotatably about a horizontal axis. The paper feeder 3 feeds the web paper WP from the roll of the web paper WP to the printing apparatus body 5. The printing apparatus body 5 performs printing on the elongated web paper WP. Then, the take-up roller 7 winds up the web paper WP printed by the printing apparatus body 5 around a horizontal axis. The take-up roller 7 includes an electric motor configured to wind up the web paper WP. If it is assumed that the side from which the web paper WP is fed as upstream and the side to which the web paper WP is taken up as downstream, the paper feeder 3 is located upstream of the printing apparatus body 5. Here, the web paper WP corresponds to the print medium in the present invention.

The printing apparatus body 5 includes a drive roller 9, a drive roller 11, a plurality of transport rollers 13, and nip rollers 15. The drive roller 9 is located adjacent to an inlet of the printing apparatus body 5. The drive roller 11 is located adjacent to an outlet of the printing apparatus body 5. The drive rollers 9 and 11 are each supported rotatably, and are each driven by an electric motor. The drive roller 9 takes up the web paper WP from the paper feeder 3. The drive roller 11 feeds out the web paper WP to the take-up roller 7. The drive rollers 9 and 11 each apply power for transportation to the web paper WP. The transport rollers 13 are supported rotatably, and guide the web paper WP, and are driven rollers that rotate drivenly by contacting the moving web paper WP. The transport rollers 13 include no electric motor, and apply no power for transportation to the web paper WP, which differs from the drive roller 11.

The printing apparatus body 5 further includes a printing unit 19, a drying mechanism 21, a cooling unit 23, and an inspecting unit 25 in this order from upstream.

The printing unit 19 causes inks (ink droplets) to adhere to a printing face FF of the web paper WP to be transported. The printing unit 19 includes four inkjet heads 19A to 19D, for example. The four inkjet heads 19A to 19D eject ink droplets by a piezoelectric element system or a thermal (bubble) system, for example. The most upstream inkjet head 19A ejects black (K) ink droplets. The next inkjet head 19B ejects cyan (C) ink droplets. The next inkjet head 19C ejects magenta (M) ink droplets. The next inkjet head 19D ejects yellow (Y) ink droplets.

Here in this embodiment, the printing unit 19 includes the four inkjet heads 19A to 19D, but this is not limitative. For example, the printing unit 19 may include one inkjet head, or two or six inkjet heads.

The drying mechanism 21 heats the web paper WP unloaded (transported) from the printing unit 19 to dry inks. The detailed construction of the drying mechanism 21 is to be mentioned later. The cooling unit 23 cools the web paper WP heated by the drying mechanism 21. The cooling unit 23 includes, for example, a water-cooled roller containing a flow path through which cooling water flows. The inspecting unit 25 includes a charge coupled device (CCD) sensor or a contact image sensor (CIS), for example. The inspecting unit 25 inspects figures printed on the web paper WP.

The printing apparatus 1 includes a controller 27 and a memory unit (e.g., memory) not shown. The controller 27 includes a central processing unit (CPU). The controller 27 controls components of the printing apparatus 1 (e.g., printing unit 19 and drying mechanism 21). The memory unit stores programs necessary for operation of the printing apparatus 1.

### Construction of Drying Mechanism

The following describes the drying mechanism 21 as the characteristic of the present invention with FIGS. 2 and 3. FIG. 3 is a schematic diagram showing details of the transportation path of the web paper WP in the drying mechanism 21.

### (a) Construction of Rollers

The drying mechanism 21 includes guide rollers R, a printing face contact roller 29, transport rollers 31, and path changing rollers 33. Here, the transport rollers and the printing face contact roller are each referred to as a “roller” appropriately. The printing face FF of the web paper WP is a face to which the printing unit 19 causes inks to adhere. A rear face BF is a face opposite to the printing face FF, to which no inks from the printing unit 19 adhere.

The guide rollers R, the printing face contact roller 29, the transport rollers 31, and the path changing rollers 33 are each a driven roller like the transport rollers 13 described above. Specifically, guide rollers R, the printing face contact roller 29, the transport rollers 31, and the path changing rollers 33 are each supported rotatably, and guide the web paper WP. The guide rollers R, the printing face contact roller 29, the transport rollers 31, and the path changing rollers 33 include no electric motor, apply no power for transportation of the web paper WP, and rotate drivenly by contacting the moving web paper WP.

It is assumed in the first embodiment that seven guide rollers R are provided. As shown in FIGS. 2 and 3, the guide rollers R are distinguished individually by numerals R1 to R7, starting from upstream of the web paper WP in the transportation direction. That is, among the guide rollers R, a guide roller R1 is located at the most upstream side, and a guide roller R7 is located at the most downstream side.

The guide rollers R each contact the rear face BF of the web paper WP unloaded from the printing unit 19 to turn the transportation direction of the web paper WP. The printing face contact roller 29 is located downstream of the seven guide rollers R1 to R7. The printing face contact roller 29 is a roller among the plurality of rollers of the drying mechanism 21 (printing apparatus 1) that firstly contacts the printing face FF of the web paper WP. The printing face contact roller 29 also has a function of changing the transportation direction of the web paper WP. The web paper WP, which is unloaded from the printing unit 19 and loaded through an inlet of the drying mechanism 21, is transported by the guide rollers R1 to R7 in a swirling form.

Here, a path for transporting the web paper WP by means of the guide rollers R1 to R7 is to be described. Firstly, the web paper WP unloaded from the printing unit 19 is transported to the transport roller 13A, the guide roller R1, the guide roller R2, and the guide roller R3 in this order. The transport roller 13A and guide rollers R1 to R3 are located downstream of the printing unit 19 and forward of the printing unit 19 in plan view.

The transport roller 13A is located downstream of the printing unit 19 (i.e., inkjet head 19D on the most downstream) and upstream of the guide roller R3. The transport roller 13A is located adjacent to the inkjet head 19D. The transport roller 13A contacts the rear face BF of the web paper WP. The transport roller 13A, the guide roller R1, and the guide roller R2 each guide the web paper WP diagonally downward such that the printing face FF of the web paper WP is directed upward. An inclination angle (absolute value) of the web paper WP increases toward the guide roller R3. The guide roller R3 turns a direction of the web paper WP, whose direction is turned by the rollers 13A, R1, and R2, vertically upward.

After transported to the guide roller R3, the web paper WP is transported to the guide rollers R4, R5, R6, and R7 in this order. The guide roller R4 turns a direction of the web paper WP, whose direction is turned by the guide roller R3, diagonally downward such that the printing face FF of the web paper WP is directed downward.

The guide roller R5 is positioned lower in level than the guide roller R4. The guide roller R5 turns a direction of the web paper WP diagonally upward such that the printing face FF of the web paper WP is directed downward.

The guide roller R6 is positioned higher in level than the guide roller R5. Moreover, the guide roller R6 is positioned substantially equal in level to the guide roller R4. The guide roller R6 turns a direction of the web paper WP, whose direction is turned by the guide roller R5, vertically upward.

The guide roller R7 is positioned higher in level than the guide roller R6. The guide roller R7 is positioned substantially equal in level to the guide roller R3. Moreover, the guide roller R7 is located between the guide roller R6 and a part of the web paper WP, transported from the transport roller 13A to the guide roller R3. The guide roller R7 turns a direction of the web paper WP, whose direction is turned by the guide roller R6, diagonally downward such that the printing face FF is directed upward.

Here, as shown in FIG. 2, the four guide rollers R3, R4, R6, and R7 are arranged in substantially a rectangular shape when seen from a width direction orthogonal with respect to a transportation direction TD of the web paper WP. The width direction of the web paper WP corresponds to a y-direction in FIG. 1 and the like. As shown in FIG. 2, the printing face contact roller 29 is located so as to be surrounded by the four guide rollers R3, R4, R6, and R7. In other words, the printing face contact roller 29 is surrounded by a part of the web paper WP transported from the guide roller R3 to the guide roller R7.

The printing face contact roller 29 firstly contacts the printing face FF of the web paper WP after the inks adhere. The printing face contact roller 29 folds the web paper WP with the inks being dried, thereby guiding the web paper WP toward an outlet of the drying mechanism 21. Specifically, not only the printing face contact roller 29 but the transport roller 31 guide the web paper WP to the outlet of the drying mechanism 21.

The transport roller 31 is located downstream of the printing face contact roller 29. In the first embodiment, it is assumed that nine transport rollers 31 are provided in the drying mechanism 21. While passing the web paper WP through a clearance CL1 formed by a part of the web paper WP transported between the transport roller 13A and the guide roller R3 and a part of the web paper WP transported between the guide roller R7 and the printing face contact roller 29, the nine transport rollers 31 guide the web paper WP, folded by the printing face contact roller 29, to the outlet of the drying mechanism 21.

Here, it is assumed that, of the section where the web paper WP is transported, a section where heating units H1 to H4 to be mentioned later are located is hereinafter referred to as a “first section”. Moreover, as shown in FIG. 3 and the like, a part of the web paper WP in the first section is designated as web paper WPa. The guide rollers R1 to R6 transport the web paper WPa in the first section. The guide roller R7 is a guide roller R located downstream of the first section and closest to the first section among the guide rollers R.

Here, it is assumed that, of the section where the web paper WP is transported, a section where the web paper WP is transported from the guide roller R7 to the printing face contact roller 29 is hereinafter referred to as a “second section”. Specifically, as shown in FIG. 3 and the like, a section from a contact point P2 between the web paper WP and the guide roller R7 to a contact point P3 between the web paper WP and the printing face contact roller 29 corresponds to the second section. Moreover, as shown in FIG. 3 and the like, a part of the web paper WP in the second section is designated as web paper WPb.

Moreover, it is assumed that, of the section where the web paper WP is transported, a section where the web paper WP is transported by the transport roller 31 is hereinafter referred to as a “third section”. Specifically, as shown in FIG. 3 and the like, a section downstream of a contact point P3 between the web paper WP and the printing face contact roller 29 corresponds to the third section. Moreover, as shown in FIG. 3 and the like, a part of the web paper WP in the third section is designated as web paper WPc.

The path changing rollers 33 are each located downstream of the guide rollers R and upstream of the printing face contact roller 29 in a transportation direction TD of the web paper WP. Moreover, the path changing rollers 33 are positioned downstream of the guide roller R7. It is assumed in the first embodiment that four path changing rollers 33 are provided. As shown in FIG. 3, the path changing rollers 33 are distinguished individually by numerals 33A to 33D, starting from upstream of the web paper WP in the transportation direction. That is, among the path changing rollers 33, a path changing roller 33A is located at the most upstream side, and a path changing roller 33D is located at the most downstream side. Here, the guide rollers R and the path changing rollers 33 each correspond to the turning roller in the present invention.

The path changing rollers 33 each contact the rear face BF of the web paper WPb in the second section to change the transportation path of the web paper WPb in the second section. That is, the web paper WPb in the second section is wound around each of the path changing rollers 33, and the transportation path of the web paper WP is changed and bypassed from a straight path Wv indicated by dotted lines in FIG. 3 to a path that bypasses the straight path Wv. The path that bypasses the straight path Wv, indicated by a numeral Wpb and solid lines in FIG. 3 and the like, is longer than the straight path Wv. That is, the path changing rollers 33 each elongate the path of the web paper WPb in the second section. Note that the details of the transportation path of the web paper WPb in the second section is to be described later.

### (B) Construction of Heating Unit

The drying mechanism 21 also includes four heating units H1 to H4. The four heating units H1 to H4 heat the web paper WP guided into the drying mechanism 21. The heating unit H1, the heating unit H2, the heating unit H3, and the heating unit H4 are arranged in this order along the transportation path of the web paper WP. That is, of the four heating units H1 to H4, the heating unit H1 is located on the most upstream side. The four heating units H1 to H4 heat the web paper WP in a non-contact manner.

The heating unit H1 faces the printing face FF of the web paper WP between the guide roller R1 and the guide roller R2. That is, the heating unit H1 is located adjacent to the printing face FF of the web paper WP transported between the guide roller R1 and the guide roller R2.

The heating unit H2 faces the printing face FF of the web paper WP between the guide roller R2 and the guide roller R3. The heating unit H3 faces the printing face FF of the web paper WP between the guide roller R3 and the guide roller R4. The heating unit H4 faces the printing face FF of the web paper WP between the guide roller R6 and the guide roller R7. That is, none of the four heating units H1 to H4 in the present embodiment faces the rear face BF of the web paper WP.

Moreover, the web paper WP is transported between the guide roller R4 and the guide roller R6 without being heated by any heating unit. The following describes the reason for the above. The printing face FF is directed downward between the guide roller R4 and the guide roller R6. Accordingly, if the front side face (adjacent to a heating portion) of the heating unit faces the printing face FF, the front face of the heating unit is directed upward. This leads to overheating of the web paper WP due to contacting the front side face of the heating unit when the web paper WP slackens. Then, in order to avoid overheating of the web paper WP, the web paper WP is transported between the guide roller R4 and the guide roller R6 without being heated by any heating unit.

As described above, the heating units H1 to H4 are each arranged to face the printing face FF of the web paper WP in the first section. Then, the heating units H1 to H4 heat the web paper WP facing thereto in the first section directly, thereby drying the inks on the printing face FF. The heating units H1 to H4 each correspond to the drying unit in the present invention.

As one example, the heating units H1 to H4 each heat the printing face FF of the web paper WP with infrared rays (electromagnetic waves). When heating the web paper WP with infrared rays, the heating units H1 to H4 are preferably arranged so as to heat the printing face FF of the web paper WP transported between adjacent two guide rollers R. As one example, the heating unit H1 heats the web paper WP transported between adjacent guide rollers R1 and R2 with infrared rays.

Here, the guide roller R1 and the guide roller R2 are configured not to enter a region where the heating unit H1 applies infrared rays (heating region). By arranging the guide rollers R so as not to enter the heating region, excessive heating of the guide rollers R can be prevented. This is similarly applicable to the other heating units H2 to H4.

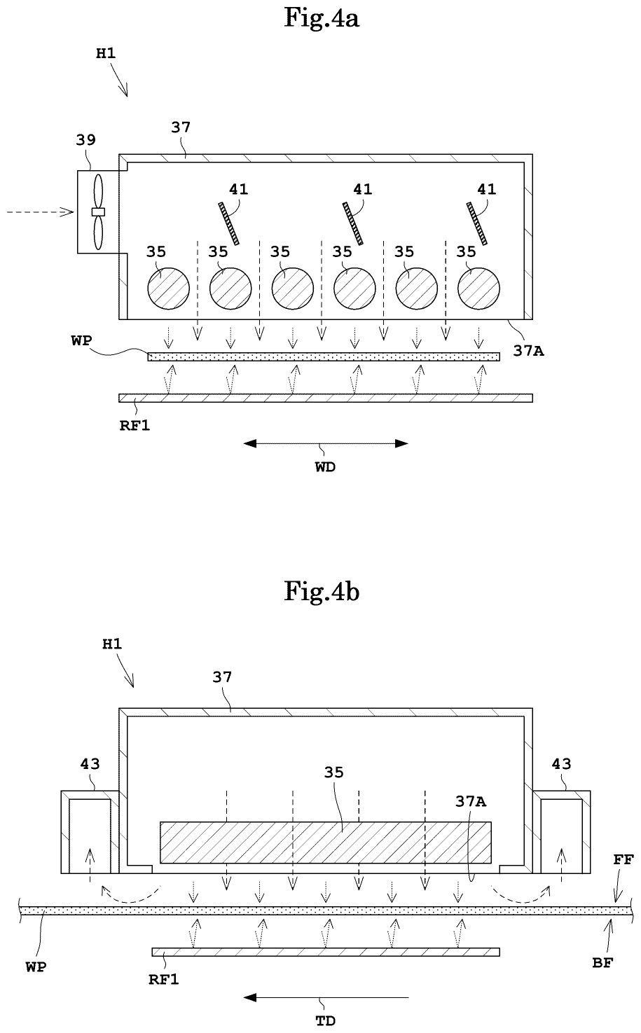

FIG. 4a is a longitudinal sectional view of the heating unit H1 along a width direction WD of the web paper WP. FIG. 4b is a longitudinal sectional view of the heating unit H1 along a transportation direction TD of the web paper WP. The width direction WD is orthogonal to the transportation direction TD. The four heating units H1 to H4 have the same construction. Accordingly, the following describes a detailed construction of a first heating unit H1 as a representative of the above heating units.

The heating unit H1 includes a plurality of carbon heaters 35 configured to emit infrared rays to the web paper WP. The carbon heaters 35 are located to be flush with one another along the width direction WD. The carbon heaters 35 are each formed in a bar shape, and are arranged longitudinally along the transportation direction TD. Accordingly, the carbon heaters 35 are arranged in a two-dimensional plane so as to be in parallel to the web paper WP. It should be noted that the first heating unit H1 may include not a plurality of carbon heaters 35 but one carbon heater 35. In this case, the one carbon heater 35 bends to be arranged in a two-dimensional plane.

The carbon heaters 35 emit infrared rays to the printing face FF, allowing direct heating of the printing face FF (inks and web paper WP). With use of the carbon heaters 35, infrared rays having an optimum wavelength for heating (drying) the inks can be emitted. That is, the carbon heaters 35 can emit infrared rays with a wavelength that are easily absorbed into water.

The carbon heaters 35 are accommodated in a casing 37. The casing 37 is formed in a cuboid shape. The casing 37 has an opened front face 37A. It should be noted that a grid fence, not shown, may be provided at the front face 37A so as to prevent contact of the web paper WP to the carbon heaters 35.

The heating unit H1 includes an air-blowing fan 39 and guide plates 41. The air-blowing fan 39 is provided on a side face of the casing 37, and is driven by an electric motor. The air-blowing fan 39 blows gas into the casing 37. Thereby, ambient gas around the carbon heaters 35 that is heated with the carbon heaters 35 can be fed out to the printing face FF. Moreover, the guide plates 41 are provided within the casing 37, and are configured to cause wind to flow uniformly from the front face 37A of the casing 37. That is, the first heating unit H1 is configured to heat the printing face FF with radiant heat of the carbon heaters 35 and also to blow warm air to the printing face FF.

The heating unit H1 includes two exhaust units 43. The two exhaust units 43 are provided on upstream and downstream side faces of the casing 37 so as to sandwich the casing 37, accommodating the carbon heaters 35 and the like, in the transportation direction TD of the web paper WP. The two exhaust units 43 each have an opening directed toward the printing face FF. Thereby, warm air that the air-blowing fan 39 blows through the front face 37A can be exhausted upstream and downstream of the casing 37. The number of the exhaust units 43 in the heating unit H1 is variable appropriately.

Moreover, as shown in FIGS. 2, 4a, and 4b, the printing apparatus 1 includes four reflectors RF1 to RF4. The reflector RF1 faces the heating unit H1 across the web paper WP transported between the guide roller R1 and the guide roller R2. Likewise, the reflector RF2 faces the heating unit H2 across the web paper WP transported between the guide roller R2 and the guide roller R3. The reflector RF3 faces the heating unit H3 across the web paper WP transported between the guide roller R3 and the guide roller R4. The reflector RF4 faces the heating unit H4 across the web paper WP transported between the guide roller R6 and the guide roller R7.

The four reflectors RF1 to RF4 are each formed by glossy metal. The four reflectors RF1 to RF4 each reflect infrared rays emitted from the carbon heaters 35 and passing through the web paper WP. The reflected infrared rays can again be emitted to the web paper WP. This can lead to effective usage of the infrared rays emitted from the carbon heaters 35.

As shown in FIG. 2 and the like, the front faces 37A of the heating units H1 to H4 are arranged so as to surround the web paper WPa in the first section and the web paper WPb in the second section. With such arrangement, a temperature of a space where the web paper WPa and the web paper WPb are transported easily increases by the heating units H1 to H4, which facilitates drying of the inks printed on the web paper WPa and the web paper WPb.

The drying mechanism 21 also includes an exhaust gas collecting unit, not shown. The exhaust gas collecting unit is located above the rollers 13A, R1 to R8, 31, 33 and the four heating units H1 to H4. The exhaust gas collecting unit is connected to the exhaust units 43 of the four heating units H1 to H4 individually. The exhaust gas collecting unit collects gas sucked from the exhaust units 43 individually, and feeds the collected gas to an exhaust duct in a factory where the printing apparatus 1 is installed.

### (C) Transportation Path of Web Paper in Second Section

Here, a path for transporting the web paper WP in the second section is to be described. Firstly, the web paper WP wound by the guide roller R7 is transported to the path changing roller 33A, the path changing roller 33B, the path changing roller 33C, the path changing roller 33D, and the printing face contact roller 29 in this order.

The path changing roller 33A is located between the guide roller R3 and the guide roller R7. Moreover, the path changing roller 33A is positioned substantially equal in level to the guide rollers R3 and R7. That is, the web paper WP wound around the guide roller R7 is transported substantially horizontally toward a front part in the drying mechanism 21, and then is wound around the path changing roller 33A.

The path changing roller 33B is positioned forward of the path changing roller 33A and lower in level than the path changing roller 33A. The web paper WP wound around the path changing roller 33A is transported diagonally downward while the printing face FF thereof is directed upward, and then is wound around the path changing roller 33B.

At this time, a positional relationship between the path changing rollers 33A and 33B is adjusted in advance so that the printing face FF of the web paper WPb in the second section transported between the path changing rollers 33A and 33B is directed toward the heating unit H2. That is, the web paper WPb in the second section transported between the path changing rollers 33A and 33B is arranged so as to face the heating unit H2 across the web paper WPa in the first section. In other words, the web paper WPb in the second section transported between the path changing rollers 33A and 33B is transported in parallel to the web paper WPa transported between the guide rollers R2 and R3.

By arranging the printing face FF so as to face the heating unit H2, the web paper WPb in the second section transported between the path changing rollers 33A and 33B is easily heated indirectly by the heating unit H2. Moreover, a distance between the path of the web paper WPb between the path changing rollers 33A and 33B and the path of the web paper WPa between the guide rollers R2 and R3 is preferably made small. By moving the path of the web paper WPb closer to the path of the web paper WPa, the web paper WPb can be heated more efficiently when the heating unit H2 indirectly heats the web paper WPb in the second section.

The path changing roller 33C is positioned lower in level than the path changing roller 33B. The web paper WP wound around the path changing roller 33B is transported vertically downward, and then is wound around the path changing roller 33C. At this time, a positional relationship between the path changing rollers 33B and 33C is adjusted in advance so that the printing face FF of the web paper WPb in the second section transported between the path changing rollers 33B and 33C is directed toward the heating unit H3.

That is, the web paper WPb in the second section transported between the path changing rollers 33B and 33C is arranged so as to face the heating unit H3 across the web paper WPa in the first section. In other words, the web paper WPb in the second section transported between the path changing rollers 33B and 33C is transported in parallel to the web paper WPa transported between the guide rollers R3 and R4.

By arranging the printing face FF so as to face the heating unit H3, the web paper WPb in the second section transported between the path changing rollers 33B and 33C is easily heated indirectly by the heating unit H3. Moreover, a distance between the path of the web paper WPb between the path changing rollers 33B and 33C and the path of the web paper WPa between the guide rollers R3 and R4 is preferably made small. By moving the path of the web paper WPb closer to the path of the web paper WPa, the web paper WPb can be heated more efficiently when the heating unit H3 indirectly heats the web paper WPb in the second section.

The path changing roller 33D is positioned lower in level than the path changing roller 33C. The web paper WP wound around the path changing roller 33C is transported diagonally downward while the printing face FF thereof is directed downward, and then is wound around the path changing roller 33D. Moreover, a positional relationship between the path changing roller 33D and the printing face contact roller 29 is adjusted in advance such that the web paper WP wound around the path changing roller 33D is transported vertically upward and then is wound around the printing face contact roller 29.

As described above, the web paper WPb in the second section is transported with the path changing rollers 33 in a swirling form so as to bypasses the straight path Wv, and is guided from the guide roller R7 to the printing face contact roller 29.

### (D) Construction of Ventilation Duct

The drying mechanism 21 in the first embodiment also includes four ventilation ducts 51. The ventilation ducts 51 are arranged along the transportation path of the web paper WPb in the second section. The ventilation duct 51 reduces humidity, especially around the web paper WPb by ventilating an interior space of the drying mechanism 21.

The drying mechanism 21 in the first embodiment includes the path changing rollers 33A to 33D, thereby largely enhancing the drying efficiency of the inks on the web paper WPb in the second section. Here, the inks are dried efficiently on each of the web paper WPa in the first section and the web paper WPb in the second section, so that vapor generated from the web paper WP by drying easily stagnates inside the drying mechanism 21. Especially when the transportation path of the web paper WPb in the second section is made closer to the transportation path of the web paper WPa in the first section with the path changing rollers 33, the web paper WPb in the second section is closer to the web paper WPa in the first section or the web paper WPc in the third section. As a result, vapor stagnation is particularly likely to occur around the web paper WPb in the second section. If vapor stagnation occurs, there is a concern that the drying efficiency of the inks on the web paper WP decreases.

Therefore, in the drying mechanism 21 in the first embodiment, the ventilation duct 51 is installed along the transportation path of the web paper WPb in the second section, leading to prevention of vapor stagnation around the web paper WPb, especially in the second section. The ventilation duct 51 is preferably located between the web paper WPb in the second section and the web paper WPc in the third section, as shown in FIG. 3 and the like. Since the space between the two adjacent transportation paths is a place where vapor is especially likely to stagnate, placing the ventilation duct 51 in such a place can avoid vapor stagnation inside the drying mechanism 21 more reliably.

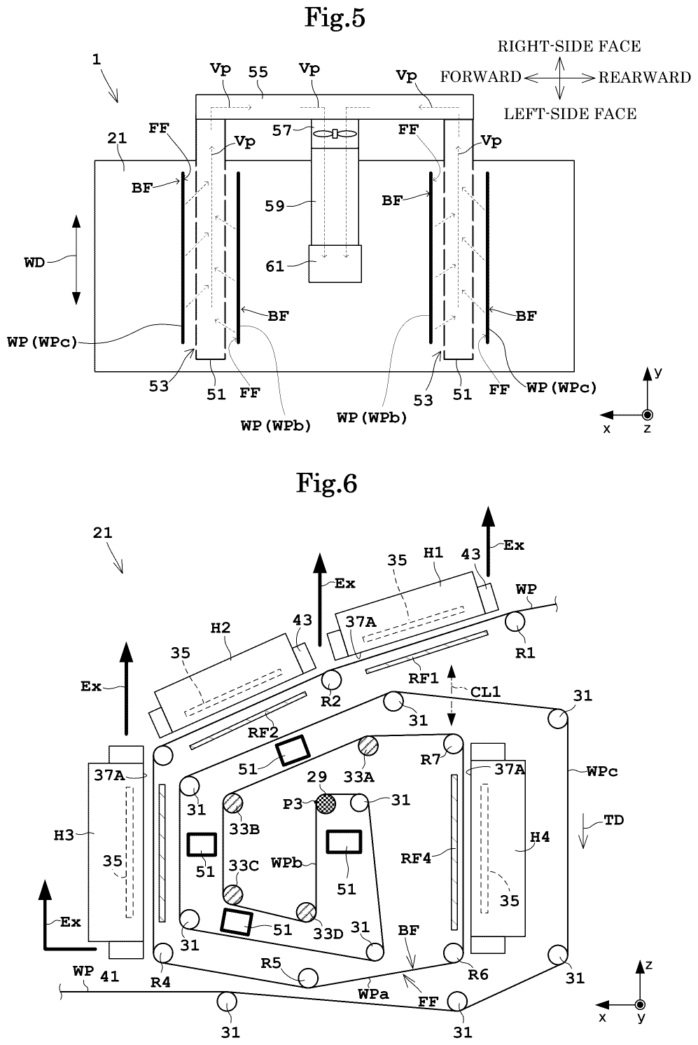

The following describes a construction of the ventilation duct 51 with reference to the drawings. FIG. 5 is a cross-sectional view on the A-A arrow in FIG. 3. FIG. 5 corresponds to a cross-sectional view of the heating mechanism 21. The ventilation duct 51 is arranged so as to extend in the drying mechanism 21 in a width direction WD of the web paper WP. A plurality of vent holes 53 is formed on lateral sides of ventilation duct 51 over the width direction WD. The vent holes 53 allow air around the web paper WP to be sucked in and guided into the ventilation duct 51.

Each of the ventilation ducts 51 has a first end protruding outside the drying mechanism 21 toward a right side face of the drying mechanism 21 (toward back in FIG. 1). Each of the vent holes 53 is formed from the outside and a second end of the ventilation duct 51 toward the inside and the first end of the ventilation duct 51. Accordingly, fluid (air as an example) guided into the ventilation duct 51 via the vent holes 53 can easily flow from the second end to the first end of the ventilation duct 51.

The first end of each of the ventilation duct 51 is connected to a vent pipe 55. The vent pipe 55 is connected in fluid communication with a connecting pipe 59 via a circulation fan 57. The connecting pipe 59 is connected in fluid communication with a circulation pipe 61. The circulation fan 57 is configured to feed air inside the vent pipe 55 into inside of the connecting pipe 59. The connecting pipe 59 is connected from a right side of the drying mechanism 21 to an interior of the drying mechanism 21. The circulation pipe 61 extends in the vertical (z-direction) and other directions, as an example, and is connected to the heating units H1 to H4 and the like.

In FIG. 5, humid air flow generated around the web paper WP due to heating and drying of the web paper WP is shown by a numeral Vp and dotted lines. That is, air Vp sent into the ventilation duct 51 via the vent holes 53 is sent to the first end of the ventilation duct 51 and is guided to vent pipe 55. The air Vp guided into the vent pipe 55 is circulated by the circulation fan 57 to the inside of the connecting pipe 59, i.e., the drying mechanism 21.

Air Vp sent to the connecting pipe 59 is sent to the heating units H1 to H4 via the circulation pipe 61 to be heated and dried. The heated and dried air Vp is exhausted to the outside of the heating units H1 to H4 through the exhaust unit 43 and the like arranged in the heating units H1 to H4. One example of the path of the air Vp exhausted to the outside of the heating units H1 to H4 is indicated by an arrow with a numeral Ex in FIG. 6. In such a manner, the humid air Vp generated around the web paper WP is efficiently exhausted by the ventilation ducts 51. This can prevent vapor stagnation around the web paper WP.

As shown in FIG. 5, lateral sides of the ventilation ducts 51 are arranged so as to face the printing face FF of web paper WP, individually. In other words, the ventilation ducts 51 are positioned between the printing face FF of web paper WP. In the present embodiment, the ventilation ducts 51 are positioned between the printing face FF of the web paper WP in the second section and the printing face FF of the web paper WP in the third section. In this case, the vent holes 53 formed on the lateral side of the ventilation duct 51 face the printing face FF of the web paper WP. When the web paper WP is dried, moisture in the inks is likely to evaporate from the printing face FF. Accordingly, humid air Vp is easily generated on the printing face FF of the web paper WP. By arranging the lateral sides of the ventilation duct 51 so as to face the printing face FF of the web paper WP, the air Vp generated around the printing face FF can be quickly guided into the ventilation duct 51. This results in an enhanced efficiency of discharging the humid air Vp.

### Description of Operation

An operation of the printing apparatus 1 will now be described with reference to FIGS. 1 and 2. The paper feeder 3 feeds the web paper WP to the printing apparatus body 5. The printing unit 19 ejects inks (ink droplets) to the web paper WP, and the web paper WP is transported to the drying mechanism 21. Here, the face of the web paper WP to which the inks adhere is the printing face FF. The face opposite to the printing face FF is the rear face BF.

Reference is made to FIG. 2. The web paper WP is transported from the transport roller 13A to the guide roller R7 in a swirling form while passing through the guide rollers R1 to R6 in the first section. The web paper WP is transported diagonally downward (i.e., a combination direction of forward and downward) within the first section from the transport roller 13A to the guide roller R2 while the printing face FF thereof is directed upward. Then, in the section from the guide roller R1 to the guide roller R2, the heating unit H1 heats the web paper WP in a non-contact manner. That is, the temperature of the web paper WP increases due to direct heating of the web paper WP by radiant heat and the like from the heating unit H1.

After receiving the heat from the heating unit H1, the web paper WP is further transported diagonally downward from the guide roller R2 to the guide roller R3 while the printing face FF thereof is directed upward. Then, in the section from the guide roller R2 to the guide roller R3, the heating unit H2 heats the web paper WP in a non-contact manner. The temperature of the web paper WP further increases due to radiant heat and the like from the heating unit H2.

After receiving the heat from the heating units H1 and H2, the web paper WP is transported vertically downward within the section from the guide roller R3 to the guide roller R4. Then, in the section from the guide roller R3 to the guide roller R4, the heating unit H3 heats the web paper WP in a non-contact manner. The temperature of the web paper WP further increases due to heating from the heating unit H3.

After receiving the heat from the heating units H1 to H3, the web paper WP is transported within the section from the guide roller R4 to the guide roller R6 while the printing face FF thereof is directed downward. Moreover, in this section, the web paper WP is transported without being heated directly by the heating units H1 to H4.

After transported to the guide roller R6, the web paper WP is transported vertically upward in the section from the guide roller R6 to the guide roller R7. In this section, the heating unit H4 heats the web paper WP in a non-contact manner. The temperature of the web paper WP further increases due to heating from the heating unit H4. That is, the temperature of the web paper WP becomes the highest when it is transported to the guide roller R7, which corresponds to a stage immediately after being heated by the heating unit H4 in the first section.

When the temperature of the web paper WP increases, the drying efficiency of the inks on the printing face FF of the web paper WP increases. In other words, an ink drying efficiency is the highest on the web paper WPa in the first section that is guided by the guide roller R7.

The web paper WP is transported to the guide roller R7, whereby transportation of the web paper WP in the first section is completed. After transported to the guide roller R7, the web paper WP is transported to the printing face contact roller 29 via the path changing rollers 33A to 33D.

The transportation path of the web paper WP in the second section from the guide roller R7 to the printing face contact roller 29 is a path that bypasses the straight path Wv from the guide roller R7 to the printing face contact roller 29. That is, in the second section, the web paper WP is transported via the path changing rollers 33A to 33D, whereby the transportation path of the web paper WP in the second section is longer than the straight path Wv. In other words, by transporting the web paper WP via the path changing rollers 33A to 33D, the web paper WP having the highest temperature is transported for a longer time. As a result, the web paper WP can be kept hotter for a longer time, so that the inks on the printing face FF are dried more efficiently before the web paper WP reaches the printing face contact roller 29.

The printing face FF of the web paper WP faces the heating unit H2 in the section of the second section between the path changing roller 33A and the path changing roller 33B. That is, the web paper WPb in the second section faces the heating unit H2 across the web paper WPa in the first section. Accordingly, warm air and radiant heat from the heating unit H2 are more efficiently transferred to the web paper WPb in this section. That is, in the section from the path changing roller 33A to the path changing roller 33B, the web paper WPb receives indirect heating by the heating unit H2 with higher efficiency, thus further enhancing ink drying efficiency.

The printing face FF of the web paper WP faces the heating unit H3 in the section of the second section between the path changing roller 33B and the path changing roller 33C. Accordingly, warm air and radiant heat from the heating unit H3 are more efficiently transferred to the web paper WPb in this section. That is, in the section from the path changing roller 33B to the path changing roller 33C, the web paper WPb receives indirect heating by the heating unit H3 with higher efficiency, thus further enhancing ink drying efficiency.

After transporting the web paper WP via the path changing rollers 33A to 33D, the printing face contact roller 29 firstly contacts the printing face FF of the web paper WP after the printing unit 19 causes the inks to adhere. The inks on the printing face FF are dried to an extent that they do not transfer due to direct and indirect heating by the heating units H1 to H4. Accordingly, the inks are prevented from transferring even when the printing face contact roller 29 contacts the printing face FF of the web paper WP. The web paper WP is transported to the printing face contact roller 29, whereby transportation of the web paper WP in the second section is completed.

The printing face contact roller 29 folds the web paper WP while contacting the printing face FF. The nine transport rollers 31 guide the web paper WP (web paper WPc in the third section), folded by the printing face contact roller 29, to the outlet of the drying mechanism 21 and to the cooling unit 23 while passing a clearance CL1 formed by the web paper WPa in the first section that is transported between the transport roller 13A and the guide roller R3 and the web paper WPb in the second section that is transported between the guide roller R7 and the path changing roller 33B. That is, the nine transport rollers 31 guide the web paper WP to the outlet of the drying mechanism 21 while guiding the web paper WP, guided toward the inside of the swirling form, toward the outside of the swirling form.

The cooling unit 23 cools the web paper WP heated by the drying mechanism 21. Thereafter, the web paper WP cooled by the cooling unit 23 is transported to the inspecting unit 25. The inspecting unit 25 inspects a printed region (characters and figures). The web paper WP inspected by the inspecting unit 25 is wound up by the take-up roller 7.

Note that efficient drying of the web paper WP leads to generation of air Vp, containing much water vapor, around the web paper WP. In the drying mechanism 21, the path of the web paper WPb in the second section is changed to bypass the straight path Wv, so that the path of the web paper WPb is closer to the path of the web paper WP in the other sections. Accordingly, humid air Vp is likely to stagnate around the web paper WPb, especially in the second section.

The air Vp stagnating around the web paper WPb is sent to the inside of the ventilation duct 51 via the vent holes 53. Then, the air Vp is sent from the ventilation duct 51 to the circulation fan 57 via the vent pipe 55, and is sent by the circulation fan 57 to the inside of the connecting pipe 59 and the circulation pipe 61. That is, the air Vp exhausted to the outside of the drying mechanism 21 by the ventilation ducts 51 is circulated back to the inside of the drying mechanism 21 by the circulation fan 57. The air Vp, which contains much water vapor, moves through the circulation pipe 61 to the heating units H1 to H4, and is heated and dried by the heating units H1 to H4. The heated and dried air Vp is diffused inside or outside the printing apparatus 1 along a path Ex and the like shown in FIG. 6.

### Effect of Construction in First Embodiment

In the printing apparatus 1 in the first embodiment, an elongated web paper WP is loaded into the drying mechanism 21 via the inlet, not shown, after the printing inks are applied to the printing face FF in the printing unit 19. After loaded into the drying mechanism 21, the web paper WP is transported by the guide rollers R and the path changing rollers 33 to the printing face contact roller 29 in a swirling form. Then, the printing face contact roller 29 contacts the printing face FF of the web paper WP to change the transportation direction of the web paper WP so that the web paper WP is turned back and the paper WP is guided to the outlet of the drying mechanism 21.

The path along which the web paper WP is transported to the printing face contact roller 29 in a swirling form includes the upstream first section and the downstream second section. The first section is a transport section where the heating units H1 to H4 are located. In the first section, the web paper WP is transported in a swirling form while being redirected by a plurality of guide rollers R contacting the rear face BF. Moreover, in the first section, a plurality of heating units H1 to H4 is arranged so as to face the printing face FF of the web paper WP.

The heat generated by the heating units H1 to H4 is directly transferred to the web paper WP transported in the first section, where the web paper WP is heated and moisture in the inks evaporates. The heating units H1, H2, H3, and H4 heat the web paper WP in turn, which raises the temperature of the web paper WP. That is, the temperature of the web paper WP becomes the highest at the downstream end of the first section.

The second section is a section where the web paper WP is transported from the guide roller R7 to the printing face contact roller 29. The guide roller R7 is a guide roller R located downstream of the first section and closest to the first section among the guide rollers R. In the second section, the web paper WP is transported to the printing face contact roller 29 by the path changing rollers 33 contacting the rear face. At this time, the path changing rollers 33 change and bypass the path of the web paper WP from the straight path Wv. That is, since the path changing rollers 33 is provided, the path of the web paper WP in the second section can be made longer.

The web paper WP has the highest temperature at the time of loading in the second section. As the temperature of the web paper WP increases, the drying efficiency of the web paper WP increases. Therefore, the web paper WP is transported within the more elongated second section while the temperature thereof is the highest, whereby moisture of the web paper WP can be further reduced before the printing face contact roller 29 contacts the printing face FF. This results in enhanced drying efficiency of the web paper WP in the drying mechanism 21 without any design change of installation of an additional heating unit in the second section or an increase in heating temperature of the heating units H1 to H4. That is, enhanced drying efficiency of the web paper WP can be made without increasing energy required for drying.

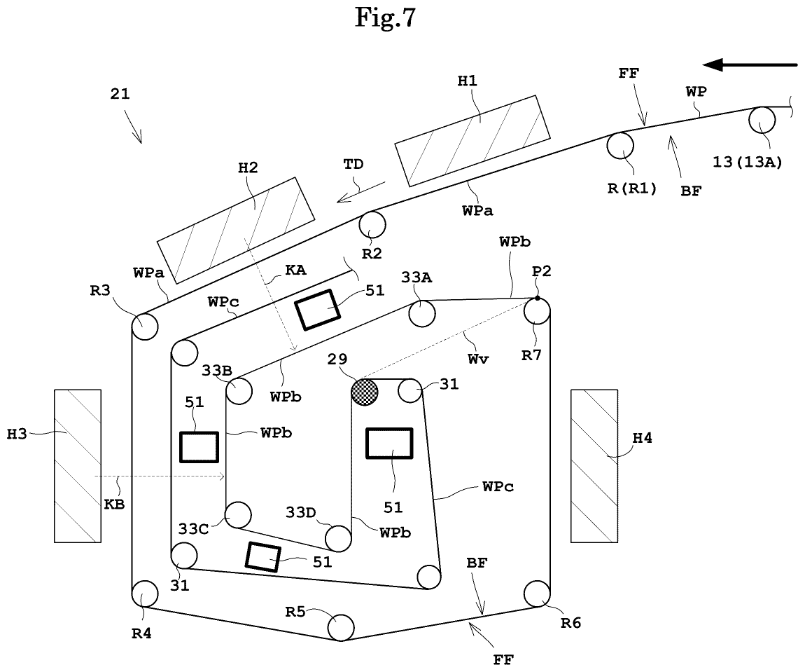

The path changing rollers 33 change the transportation path of the web paper WP in the second section so that the web paper WP in the second section faces any of the heating units H1 to H4. In the first embodiment, the transportation path of the web paper WPb is changed by path changing roller 33A so that the printing face FF of the web paper WPb in the section from the path changing roller 33A to the path changing roller 33B faces the heating unit H2. With such a path change, heat KA generated by the heating unit H2 can pass through the web paper WPa in the first section and can indirectly heat the web paper WPb in the section from the path changing roller 33A to the path changing roller 33B, as shown in FIG. 7. Since the web paper WPb from the path changing roller 33A to the path changing roller 33B is parallel to the front face 37A of the heating unit H2, the heat KA generated by the heating unit H2 is transferred perpendicularly to the web paper WPb. This can enhance the efficiency of such indirect heating by the heating unit H2.

Moreover, the transportation path of the web paper WPb is changed by path changing roller 33B so that the printing face FF of the web paper WPb in the section from the path changing roller 33B to the path changing roller 33C faces the heating unit H3. With such a path change, heat KB generated by the heating unit H3 can pass through the web paper WPa in the first section and can indirectly heat the web paper WPb in the section from the path changing roller 33B to the path changing roller 33C, as shown in FIG. 7. Since the web paper WPb from the path changing roller 33B to the path changing roller 33C is parallel to the front face 37A of the heating unit H3, the heat KB generated by the heating unit H3 is transferred perpendicularly to the web paper WPb. This can enhance the efficiency of such indirect heating by the heating unit H3.

The transportation path of the web paper WPb in the second section is arranged so as to be surrounded by the transportation path of the web paper WPa in the first section. The transportation path of the web paper WPa in the first section is arranged so as to be surrounded by the heating units H1 to H4. Accordingly, the heat from heating units H1 to H4 used to heat the web paper WPa in the first section is concentrated on the transportation path of the web paper WPb in the second section. Therefore, radiant heat and convection heat from the heating units H1 to H4 are more efficiently transferred to the web paper WPb in the second section. As a result, the web paper WPb in the second section can be maintained at a higher temperature, further enhancing the drying efficiency of the web paper WPb in the second section.

The drying efficiency of the web paper WPb is enhanced in the second section, whereby humid air Vp is generated around the web paper WPb in the second section. Such air Vp is efficiently removed from around the web paper WPb by the ventilation ducts 51 located along the transportation path of the web paper WPb in the second section. Accordingly, the drying efficiency of the web paper WPb can be prevented from decreasing due to the humid air Vp continuously stagnates around the web paper WPb.

The drying mechanism 21 also includes the circulation fan 57. The circulation fan 57 circulates the air Vp, exhausted by the ventilation ducts 51, to the inside of the drying mechanism 21. With a construction of circulating the air Vp to the inside of the drying mechanism 21, an exhaust volume by the drying mechanism 21 can be reduced. As a result, an air conditioning system for the printing apparatus 1 can be avoided from upsizing, and a thermal energy in the drying mechanism 21 can be used effectively.

### Second Embodiment

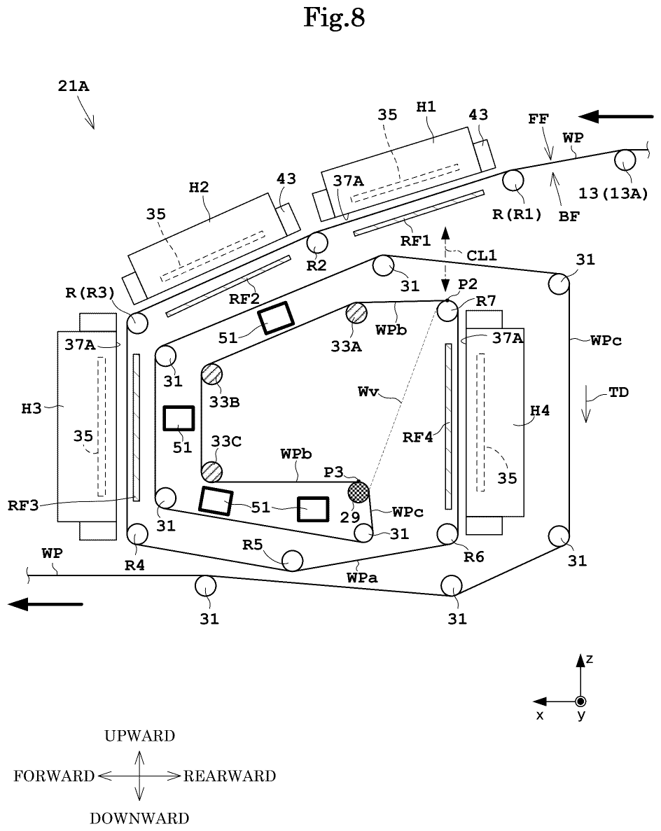

The following describes a second embodiment of the present invention with reference to the drawings. Like numerals are used to identify like components which duplicate in the first embodiment, and the components will not particularly be described. FIG. 8 illustrates a drying mechanism 21A according to the second embodiment.

The drying mechanism 21A in the second embodiment differs from the drying mechanism 21 in the first embodiment in terms of the number of path changing rollers 33 and a position of the printing face contact roller 29. As shown in FIG. 8, in the drying mechanism 21A in the second embodiment, a path changing roller 33D is omitted. Moreover, in the drying mechanism 21A, the printing face contact roller 29 is positioned at substantially the same level as the path changing roller 33C. That is, the web paper WP guided by the path changing roller 33C is transported horizontally to a back side of the drying mechanism 21A while a printing face FF thereof is directed downward. The web paper WP transported horizontally is guided to the printing face contact roller 29. Then, the printing face FF of the web paper WP contacts the printing face contact roller 29, whereby the web paper WP is folded. The folded web paper WP is transported by the transport roller 31 toward an outlet of the drying mechanism 21A.

This embodiment produces the same effect as that of the first embodiment. That is, the three path changing rollers 33A to 33C change the transportation path of the web paper WPb in the second section to a path that bypasses the straight path Wv from the guide roller R7 to the printing face contact roller 29. In other words, the transportation path of the web paper WPb in the second section is longer, achieving enhanced drying efficiency of the web paper WPb in the second section. Also, the web paper WPb whose path is changed by the path changing rollers 33A to 33C faces the heating unit H2 and heating unit H3 like in the first embodiment. Accordingly, the heat transferred indirectly from the heating units H2 and H3 heats the web paper WPb more efficiently. This results in further enhanced drying efficiency of the web paper WPb in the second section.

Moreover, in the drying mechanism 21A in the second embodiment, arrangement of the printing face contact roller 29 is changed, whereby the second section can be shortened while the path of the web paper WPb that faces the heating unit H2 and the heating unit H3 is kept. In this case, an overall transportation distance of the web paper WP in the drying mechanism 21 becomes shorter, thus reducing an amount of the web paper WP that is lost in the printing apparatus 1. In other words, the amount of the web paper WP wasted in the printing apparatus 1 can be reduced.

### Third Embodiment

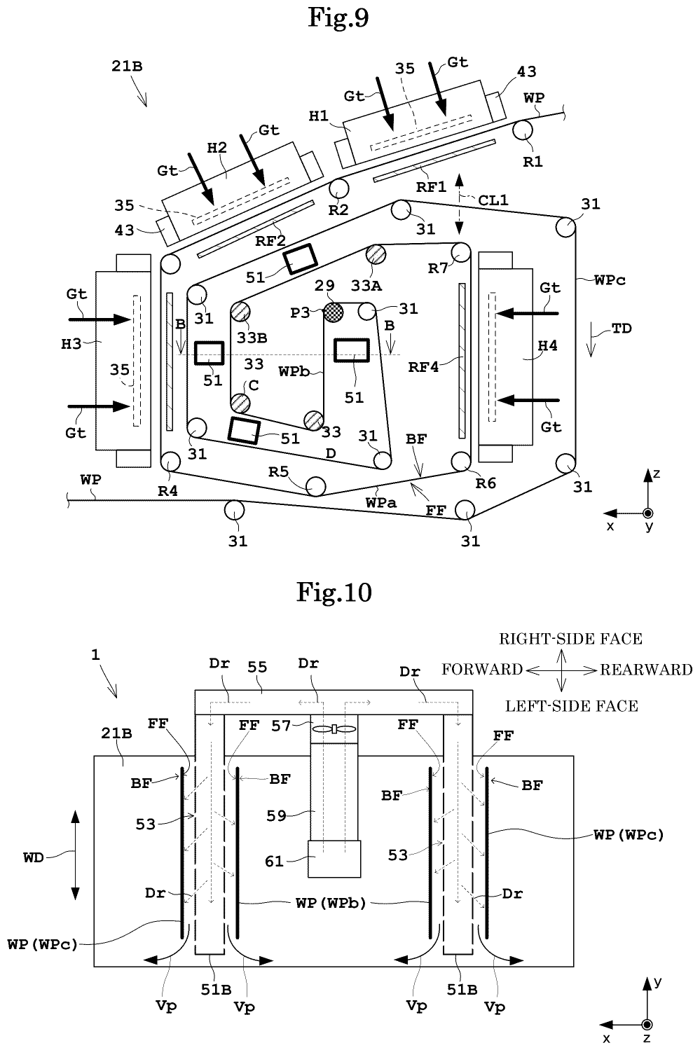

The following describes a third embodiment of the present invention with reference to the drawings. FIG. 9 illustrates a drying mechanism 21B according to the third embodiment.

In the drying mechanism 21B in the third embodiment, a position of the printing face contact roller 29 and the number of path changing rollers 33 are common to those in the drying mechanism 21 in the first embodiment. However, in the first embodiment, the ventilation duct 51 is configured to remove the humid air Vp from around the web paper WP by sucking air around the web paper WP and blowing the air to the heating units H1 to H4 and the like. On the other hand, a ventilation duct 51B in the third embodiment is configured to remove humid air Vp from around the web paper WP by heating and drying air Dr sucked by the heating units H1 to H4 and the like and then blowing the air Dr around the web paper WP.

The following describes a construction of the ventilation duct 51B with reference to FIG. 10 and the like. FIG. 10 is a cross sectional view on a B-B arrow in FIG. 9, which corresponds to a cross sectional view of the heating mechanism 21B. In the third embodiment, air Dr fed to the heating units H1 to H4 is heated and dried inside of a casing 37, and the heated and dried air Dr is guided to a circulation pipe 61. The heated and dried air Dr is sent from the circulation pipe 61 to a circulation fan 57 via a connecting pipe 59.

The circulation fan 57 circulates the air Dr to the vent pipe 55 and the ventilation ducts 51B. The air Dr circulated into the ventilation ducts 51B is exhausted outside from the vent holes 53. The air Dr exhausted outside of the ventilation ducts 51B is blown to the printing face FF of the web paper WP, which is located around the ventilation ducts 51B. Flow of the air Dr in the drying mechanism 21B is indicated by dotted lines with a numeral Dr in FIG. 10. Moreover, flow of the air Dr fed into the heating units H1 to H4 is indicated by an arrow Gt in FIG. 9.

The air Dr is blown onto the printing face FF of the web paper WP via the vent holes 53, and humid air Vp generated around the printing face FF of the web paper WP is exhausted from around the printing face FF and is diffused inside or outside the drying mechanism 21B. Flow of air Vp to be diffused is indicated by solid-line arrows in FIG. 10.

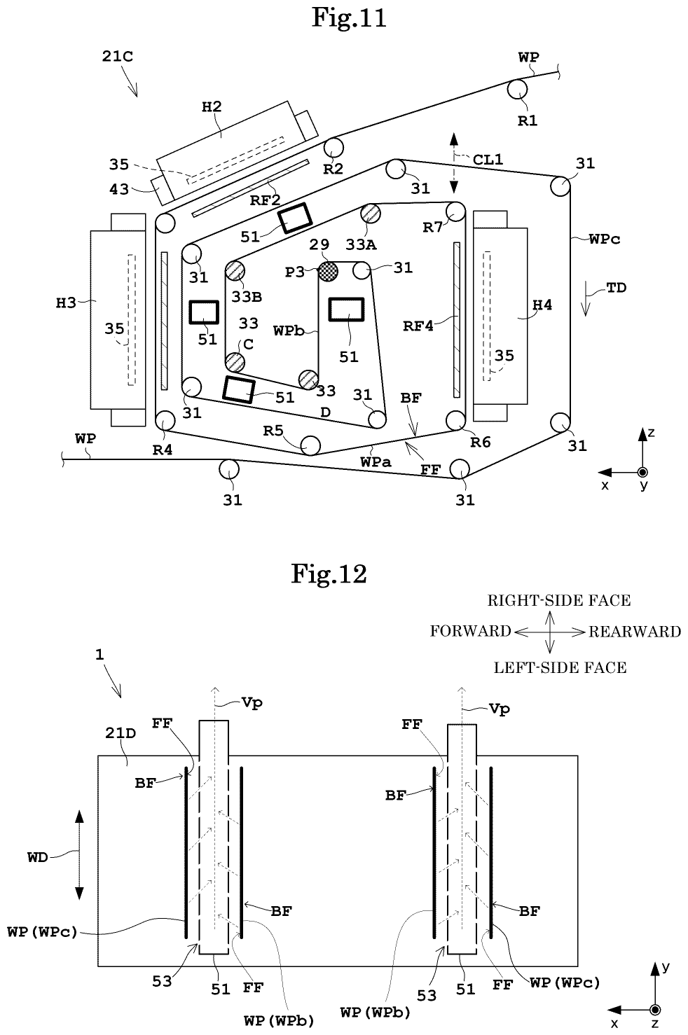

Thus, the drying mechanism 21B in the third embodiment is configured to supply the heated and dried air Dr from the ventilation ducts 51B to the printing face FF of the web paper WP. The heated and dried air Dr is supplied from the ventilation ducts 51B to the printing face FF of the web paper WP, and the humid air Vp generated around the web paper WP, especially in the second section, is exhausted from the space around the web paper WP and is diffused inside or outside the drying mechanism 21B. As a result, in the drying mechanism 21B in the third embodiment, the drying efficiency of the web paper WP can be prevented from decreasing due to stagnation of the humid air Vp around the web paper WP, which is similar in the drying mechanism 21 in the first embodiment.
(1) In each of the embodiments described above, the web paper WP in the second section whose path is changed by the path changing rollers 33 is arranged so that the printing face FF thereof faces the heating unit H2 or the heating unit H3. However, arrangement of the web paper WP in the second section is not limited to this. The path of the web paper WP in the second section may be set so that the rear face BF faces the heating unit H2 or H3.
(2) In each of the embodiments described above, the web paper WP in the second section whose path is changed by the path changing rollers 33 is not limited to have a construction where any part thereof faces the heating unit H2 or the heating unit H3. The path of the web paper WP in the second section may be set so that any part of the web paper WP in the second section faces the heating unit H1 or H4.
(3) In each of the embodiments described above, the printing apparatus 1 is not limited to include the four heating units H1 to H4. The number of heating units that the printing apparatus 1 includes may be changed as needed, as long as the effects of the present invention can be obtained. As an example, as shown in FIG. 11, the printing apparatus 1 may include a drying mechanism 21C that omits the heating unit H1. In this case, the drying mechanism 21C for this modification uses three heating units H2 to H4 to heat and dry the web paper WP.
(4) In the first embodiment described above, the ventilation duct 51 is not limited to a construction that air is circulated to the drying mechanism 21 using the circulation fan 57 and the like. FIG. 12 shows a configuration of a drying mechanism 21D for this modification. The drying mechanism 21D in this modification differs from the first embodiment in that it omits the vent pipe 55, the circulation fan 57, the connecting pipe 59, and the circulation pipe 61.

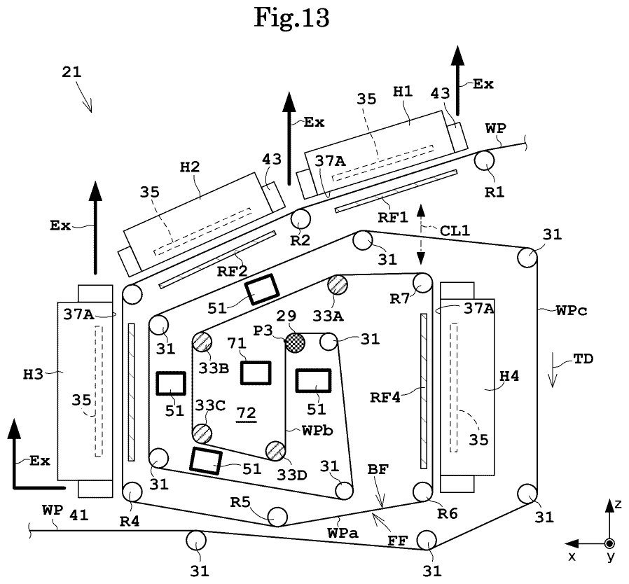

In the drying mechanism 21D in this modification, one end of the ventilation duct 51 protruding outside the drying mechanism 21D is open. That is, air Vp guided into the interior of the ventilation duct 51 via the vent holes 53 flows from the other end to the one end of the ventilation duct 51 and is exhausted from the one end of the ventilation duct 51 to the exterior of the drying mechanism 21D. In this manner, the air Vp can be efficiently exhausted from around the web paper WP, such as in the second section, even with a construction in which the humid air Vp generated around the web paper WP is exhausted directly from the ventilation duct 51 to the outside of the drying mechanism 21D. This can prevent vapor stagnation around the web paper WP.
(5) Each of the embodiments described above is not limited to have the construction in which the web paper WP is used as the printing medium. Another example of the print medium is a long thin layer material such as a film.
(6) In the first embodiment described above, the ventilation ducts 51 supply high-humidity air to the heating units H1 to H4 and the like via the circulation pipe 61. However, instead of connecting the vent pipe 55 to the circulation pipe 61 in fluid communication, the vent pipe 55 may be connected to an opening 71 formed in a side panel of the drying mechanism 21, and highly-humid air collected by the ventilation ducts 51 may be returned to an interior space of the drying mechanism 21 via the opening 71. FIG. 13 shows a preferred formation position of the opening 71. As shown in FIG. 13, the opening 71 is formed in a position that allows air to be directed into the interior space 72 enclosed by the printing face contact roller 29 and the path changing rollers 33A, 33B, and 33C. Since the interior space 72 has a larger capacity than the space where the ventilation ducts 51 are installed, returning highly-humid air to this space 72 will not have an adverse effect on drying of the web paper WP.
(7) In each of the embodiments described above, the inkjet printing system is illustrated as the printing apparatus of the present invention, but the configuration according to the present invention is applicable to a printing apparatus other than the inkjet printing apparatus such as offset printing machine.
(8) In each of the embodiments described above, the transport roller 13A, the guide rollers R, the transport rollers 31, and path changing rollers 33 may be changed as appropriate in shape, number, and arrangement as long as the effects of the present invention are obtained.

### REFERENCE SIGNS LIST

1 . . . printing apparatus
3 . . . paper feeder
5 . . . printing apparatus body
7 . . . take-up roller
9 . . . drive roller
11 . . . drive roller
13 . . . transport roller
19 . . . printing unit
21 . . . drying mechanism
23 . . . cooling unit
25 . . . inspecting unit
27 . . . control unit
29 . . . printing face contact roller
31 . . . transport roller
33 . . . path changing roller
35 . . . carbon heater
39 . . . air-blowing fan
43 . . . exhaust unit
51 . . . vent duct
53 . . . vent hole
57 . . . circulation fan
R . . . guide roller
Wv . . . straight line path
WP . . . web paper
H1 to H4 . . . heating unit
RF1 to RF4 . . . reflector

What is claimed is:

1. A printing apparatus, comprising:
a printing unit configured to cause inks to adhere to a printing face of an elongated print medium to be transported, and
a drying mechanism configured to dry the inks by heating the print medium unloaded from the printing unit,
the drying mechanism including:
a plurality of turning rollers configured to turn a transportation direction of the print medium a plurality of times by contacting a rear face of the print medium unloaded from the printing unit with no inks adhering thereto, and configured to transport the print medium in a swirling form;
a plurality of drying units arranged so as to face the printing face of the print medium transported in a swirling form, and configured to dry the inks by heating the print medium;
a printing face contact roller located downstream of a first section in a spiral transportation section of the print medium, the first section being a section where the drying units are arranged, and configured to contact the printing face of the print medium firstly to fold the print medium; and
a path changing roller located at a second section where the print medium is transported to the printing face contact roller from a turning roller of the turning rollers that is located downstream of the first section and closest to the first section, and configured to contact the rear face of the print medium in the second section to change and bypass a transportation path of the print medium.

2. The printing apparatus according to claim 1, wherein
the path changing roller
changes the transportation path of the print medium in the second section such that the print medium faces any of the drying units.

3. The printing apparatus according to claim 1, wherein
the path changing roller
changes the transportation path of the print medium in the second section such that the printing face of the print medium faces any of the drying units.

4. The printing apparatus according to claim 1, wherein
the transportation path of the print medium in the second section is arranged so as to be surrounded by the transportation path of the print medium in the first section.

5. The printing apparatus according to claim 1, further comprising:
a ventilation unit that is located along a width direction of the print medium transported in the second section and is configured to ventilate gas.

6. The printing apparatus according to claim 5, wherein
the ventilation unit is configured to supply gas, heated by the drying unit, to the second section.

7. The printing apparatus according to claim 5, wherein
the ventilation unit is configured to exhaust gas within the second section.

8. The printing apparatus according to claim 7, further comprising:
a gas circulation unit configured to circulate gas, exhausted by the ventilation unit, inside the drying mechanism.

9. The printing apparatus according to claim 5, wherein
the ventilation unit is located between the printing face of the print medium in the second section and the printing face of the print medium downstream of the second section.
